(19) United States
(12) Patent Application Publication
(10) Pub. No.: US 2016/0259887 A1
(43) Pub. Date: Sep. 8, 2016

(54) Knowledge Based Factorized High Order Sparse Learning Models

(71) Applicant: NEC Laboratories America, Inc., Princeton, NJ (US)

(72) Inventors: Renqiang Min, Princeton, NJ (US); Sanjay Purushotham, Los Angeles, CA (US)

(21) Appl. No.: 15/049,983

(22) Filed: Feb. 22, 2016

Related U.S. Application Data
(60) Provisional application No. 62/127,405, filed on Mar. 3, 2015.

(51) Int. Cl. G06F 19/24; G06N 99/00

(52) U.S. Cl. CPC G06F 19/24; G06N 99/005

(57) ABSTRACT

An optimization-driven sparse learning framework is disclosed to identify discriminative system components among system input features that are essential for system output prediction. In biomarker discovery, to handle the combinatorial interactions among gene or protein expression measurements for identifying interaction complexes and disease biomarkers, the system uses both single input features and high-order input feature interactions.

The present application claims priority to Provisional Application 62/127405 filed Mar. 3, 2015, the content of which is incorporated by reference.

### BACKGROUND

In machine learning and data mining, reliably identifying interpretable discriminative interactions among high-dimensional input features with limited training data remains a difficult problem. For example, a major challenge in biomarker discovery and personalized medicine is to identify gene/protein interactions and their relations with other physical factors in medical records to predict the health status of patients. However, we often have limited patient samples but hundreds of millions of feature interactions to consider. One approach makes sparsity and hierarchical constraint assumptions to find discriminative features and their interactions. Hierarchical constraints for high-order feature interactions are suitable for some real-world problems but are too stringent for some others. In real-world applications, we often have abundant prior information about input features that can be readily obtained from many knowledge bases.

### SUMMARY

In one aspect, a scalable knowledge based high order sparse learning framework termed a Group Factorized High order Interactions Model (Group FHIM) is disclosed for identifying discriminative feature groups and high-order feature group interactions in classification problems.

In another aspect, an optimization-driven sparse learning framework is disclosed to identify discriminative system components among system input features that are essential for system output prediction. In biomarker discovery, to handle the combinatorial interactions among gene or protein expression measurements for identifying interaction complexes and disease biomarkers, the system uses both single input features and high-order input feature interactions.

Advantages of the system may include one or more of the following. The system addresses the challenging problem of identifying high order feature interactions with scalable models by incorporating existing knowledge about input features into the model construction process. The factorization technique incorporates domain knowledge such as grouping of features directly into the decomposition factors. Unlike previous sparse learning approaches, our model can recover both the discriminative feature groups and the pairwise feature group interactions accurately without enforcing any hierarchical feature constraints. Our Group FHIM estimator is asymptotically optimal. Experiments on synthetic and real datasets show that our model outperforms the state-of-the-art sparse learning techniques, and it provides ‘interpretable’ high-order feature group interactions for gene expression prediction and peptide-MHC I binding prediction. The system provides efficient knowledge based techniques to capture the important ‘blockwise’ high-order feature and feature group interactions without making heredity assumptions.

### BRIEF DESCRIPTION OF THE DRAWINGS

FIG. 1 shows a comparison of our scalable knowledge based high order sparse learning framework termed a Group Factorized High order Interactions Model (Group FHIM).

FIG. 2 shows differences between the single-task framework and the multitask framework.

FIG. 3 shows an exemplary process for a single-task framework.

FIG. 4 shows an exemplary process for a multi-task framework.

FIG. 5 shows an exemplary processing system for operating a machine to perform FHIM.

FIG. 6 shows an exemplary physical system including an FHIM engine 212 in accordance with an embodiment of the present principles.

### DESCRIPTION

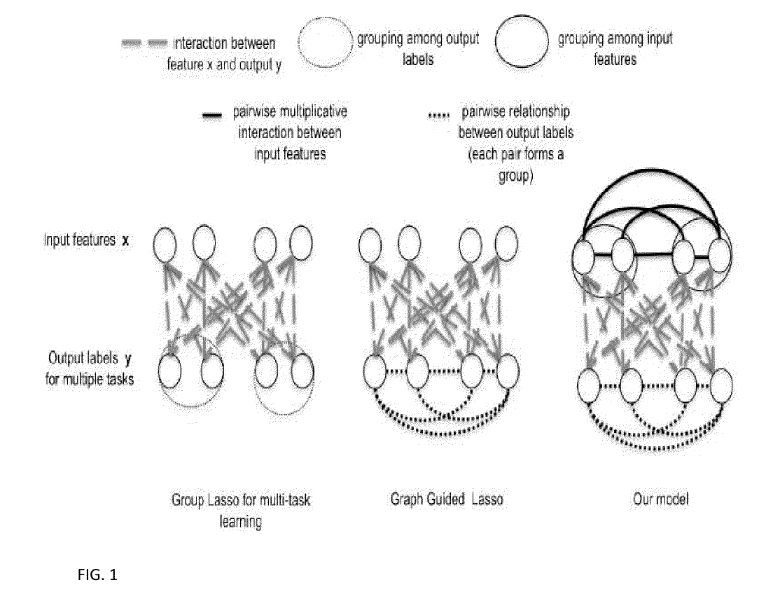

FIG. 1 shows a comparison of our scalable knowledge based high order sparse learning framework termed as Group Factorized High order Interactions Model (Group FHIM) for identifying discriminative feature groups and high-order feature group interactions in classification problems where input features x are used to generate output labels y for multiple tasks. In one approach called Group Lasso for multi-task learning, one or more output labels are assigned to particular tasks. In the graph guided Lasso approach, the outputs may be related to each other through graph connections. In the Group FHIM approach, the inputs are also related to each other through graph connections, and the inputs may also be assigned as coming from particular features. In FIG. 1 for the multitask framework, previous methods such as graph guided lasso and group lasso for multitasks only put pairwise or grouping constraints on outputs and only considers individual input features, but our model constraints both inputs and outputs to be structured. In specific, our model considers grouping information among input features, pairwise relationships between outputs, and high-order interactions among input features (we use quadratic interactions as an example).

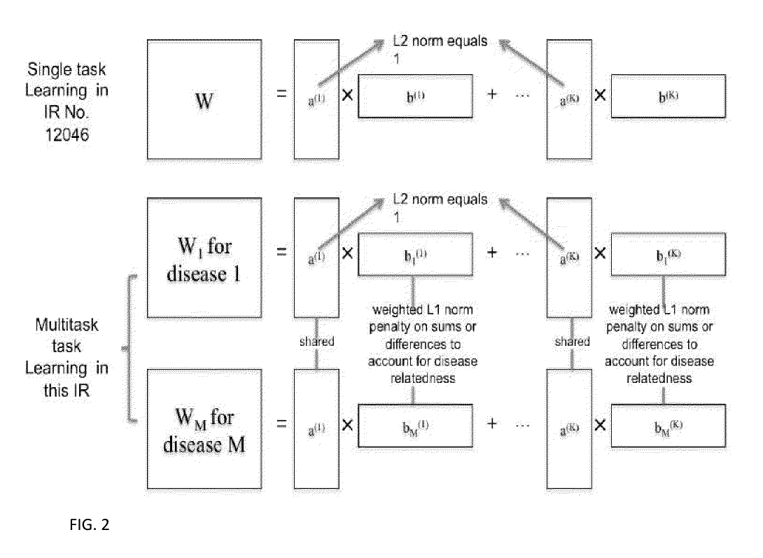

FIG. 2 shows differences between the single-task framework and the multitask framework. As shown in FIG. 1B, in both models, Ws are weight matrices for high-order feature interactions, and we use l₁ norm penalties on all vectors a and b to encourage a small number of discriminative interaction modules to be identified. For the multitask learning model, we use L2,1 norm penalties with grouping structures on the vectors a and b.

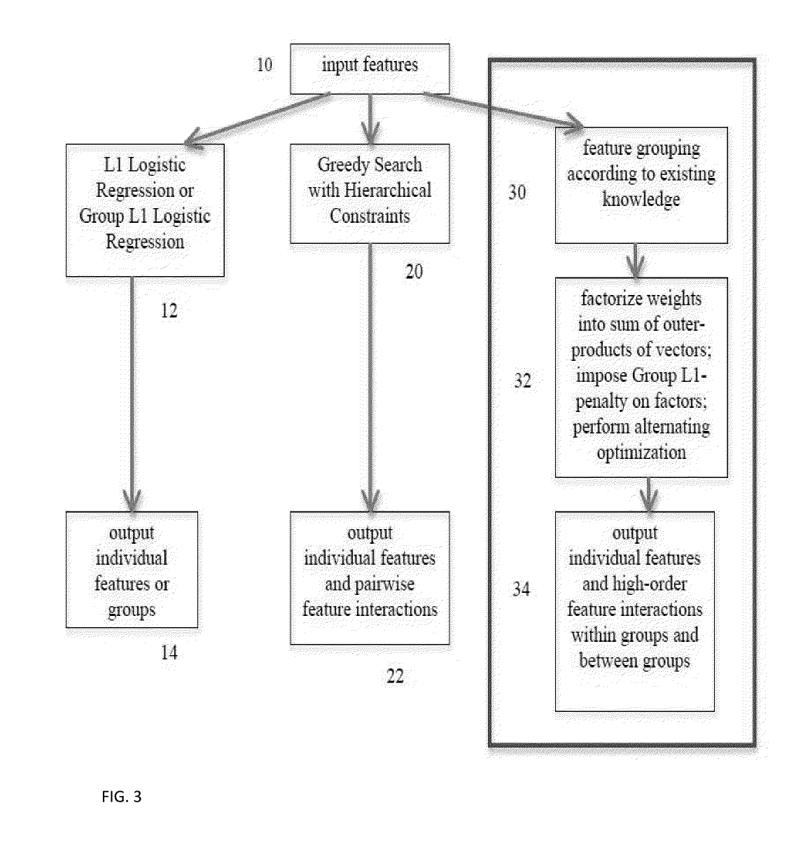

FIG. 3 shows an exemplary process for a single-task framework. Input features are received (10) and provided to three parallel determinations. In one determination, l₁ logistic regression or group L1 logistic regression is done (12) and the output can be individual features or groups of features (14). In another path, a greedy search with hierarchical constraints can be done (20) resulting in individual features and pairwise feature interactions (22). In the third path, feature grouping is done according to existing knowledge (30). The process then factorizes weights into sum of outer products of vectors; imposes group l₁ penalty on factors; and alternating optmizations (32). The process generates individual features and high-order feature interactions within groups and between groups (34).

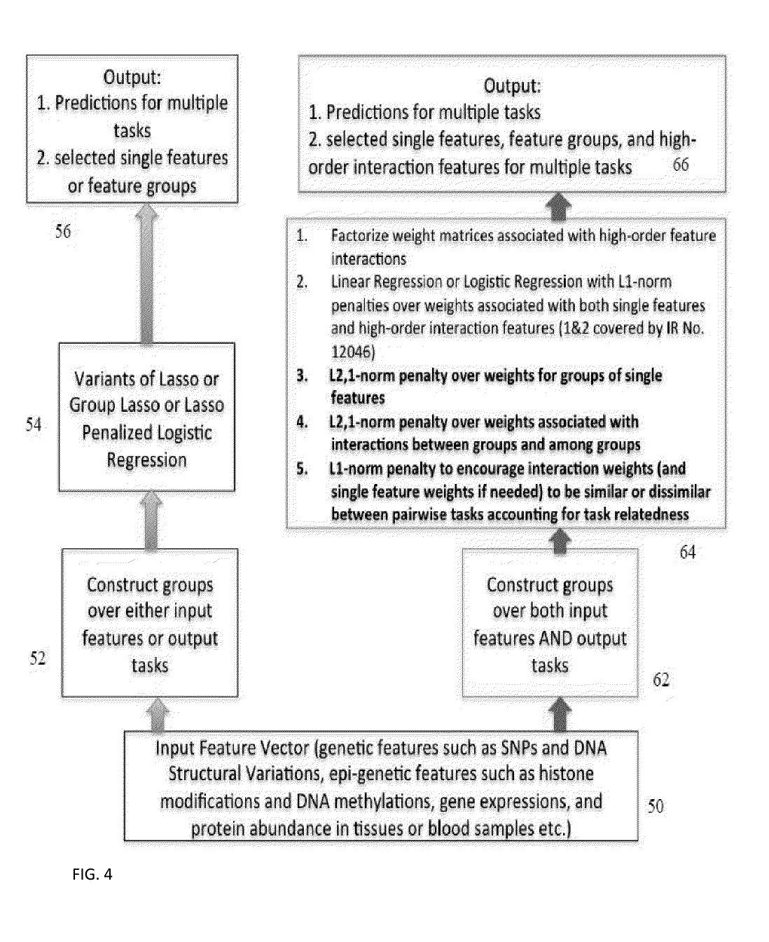

FIG. 4 shows an exemplary process for a multi-task framework. In this process, input feature vectors (for example, genetic features such as a SNPs and DNA structural variations, epi-genetic features such as histone modifications and DNA methylations and protein in tissues or blood samples) are received (50). Next, the process constructs groups over either input features or output tasks (52). Varriants of Lasso or Group Lasso Penalized Logistic Regression are applied (54), and the resulting output can be either predictions of multiple tasks or selections of single features or groups of features (56). From 50, the process can construct groups over both input features and output tasks (62). The process then groups information among input features, pairwise relationships between outputs, and high-order interactions among input features (64). In one embodiment, this includes factorizing weight matrices associated with high-order feature interactions, then performing linear regression or logistic regression with l₁ norm penalties over weights associated with single features and high order interaction features. The process then determines l_{2,1} norm penalty over: a) weights for groups of single features and b) weights associated with interactions between groups and among groups. The process also determines l₁ norm penalty to encourage interaction weights (and single feature weights if needed) to be similar or dissimilar between pairwise tasks accounting for task relatedness. The output is generated (66) and the resulting output can be either predictions of multiple tasks or selections of single features or groups of features.

Our knowledge-based sparse learning framework is based on weight matrix factorizations and l₁/l₂ regularization for identifying discriminative high-order feature group interactions in logistic regression and large-margin models. Experimental results on synthetic and real-world datasets show that our method outperforms the state-of-the-art sparse learning techniques, and it provides ‘interpretable’ blockwise high-order feature interactions for gene expression prediction and peptide-MHC I protein binding prediction. Our sparse learning framework is quite general, and can be used to identify any discriminative complex system input interactions that are predictive of system outputs given limited high-dimensional training data.

Our method is capable of simultaneously identifying both informative discriminative feature groups and discriminative high order feature group interactions in a sparse learning framework by incorporating domain knowledge. Our method works on high-dimensional input feature spaces with much more features than data samples, which is typical for biomedical applications. Our method has interesting theoretical properties for generalized linear regression models. The feature group interactions identified by our method leads to better understanding of peptide-MHC I protein interaction and gene transcriptional regulation.

In one embodiment, for any vector w, let ∥w∥₂ denote the Euclidean norm of w, and supp(w)⊂[1, p], denote the support of w, i.e. the set of features i∈[1, p] with wᵢ≠0. A group of features is a subset g⊂[1, p]. The set of all possible groups is the power set of [1, p] and let us donate it as P . Let G⊂P denote a set of groups of features. In our work, the domain knowledge is presented in terms of G. For any vector w∈R^{p}, and any group g∈G, let w_{g} denote a vector whose entries are the same as w for the features in g and 0 for other features. Let W_{g} denote a matrix of size p×p for some g∈G and the entries of W_{g} are non-zero for corresponding column entries in g (i.e. W_{g}^{ij}≠0 for g∈G and 0 otherwise). Let V_{G}∈R^{P×G} denote a set of N_{G} tuples of vector v=(v_{g})_{g∈G}, where each v_{g} is a separate vector in R^{p}, with supp(v_{g})⊂g, ∀g∈G. If two groups overlap then they share at least one feature in common.

Let {(X⁽ⁱ⁾,y⁽ⁱ⁾)}, i∈[1, n] represent a training set of n samples and p features (predictors), where X⁽ⁱ⁾∈R^{p} is the i^{th} instance (column) of the design matrix X and y(i)∈{−1,1} is the i^{th} instance of response variable (output) y. Let {β,β_{g}}∈R^{p} be the weight vector associated with single features (also called main effects) and feature groups respectively, and β₀∈R be the bias term. Note, β=Σ_{g∈G}β_{g}. Let W be the weight matrix associated with the pairwise feature group interactions and let W_{OD} be the weight matrix associated with only the pairwise feature group interactions without self interactions. W_{OD} is an off-diagonal matrix and is given by equation (7).

The system includes identifying the discriminative feature groups β_{g} and the pairwise feature group interactions W_{OD} in classification settings, when domain knowledge such as grouping of features (G) is given, and without making any heredity assumptions. For the classification settings, we can model the output in terms of features and their high order interactions using logistic regression model or large-margin models. Here we consider both these popular classifiers. A logistic regression model with pairwise interactions can be written as follows:

$$p ( {y}^{( i )} \vert {X}^{( i )} ) = \frac{1}{1 + exp ( - {y}^{( i )} ( {β}^{T} {X}^{( i )} + {X}^{( i ) T} {W}_{OD} {X}^{( i )} + {β}_{0} ) )} \qquad ( 1 )$$

The corresponding loss function (the sum of the negative log-likelihood of the training data) is given by

$${L}_{LogReg} ( β , {W}_{OD} , {β}_{0} ) = {\sum }_{i = 1}^{n} log ( 1 + exp ( - {y}^{( i )} ( {β}^{T} {X}^{( i )} + {X}^{( i ) T} {W}_{OD} {X}^{( i )} + {β}_{0} ) ) . \qquad ( 2 )$$

Similarly, we can solve the classification problem with high order interactions using large margin formulation with Hinge Loss as follows

$${L}_{Hinge} ( β , {W}_{OD} , {β}_{0} ) = {\sum }_{i = 1}^{n} max ( 0 , 1 - ( {y}^{( i )} ( {β}^{T} {X}^{( i )} + {X}^{( i ) T} {W}_{OD} {X}^{( i )} + {β}_{0} ) ) . \qquad ( 3 )$$

Next, we present our optimization-driven knowledge based sparse learning framework to identify discriminative feature groups and pairwise feature-group interactions (blockwise interactions) for the classification problems of previous section. For simplicity, here we consider that the groups do not overlap. A natural way to recover the feature groups and their interactions is by regularization as shown below.

$$\{ \hat{β} , \hat{W} \} = {argmin }_{β , W} L ( β , W ) + {λ}_{β} {\sum }_{g ∈ G}^{ } {‖ {β}_{g} ‖}_{2} + {λ}_{W} {\sum }_{g ∈ G}^{ } {‖ vec ( {W}_{g} ) ‖}_{2} \qquad ( 4 )$$

where vec(W_{g}) is the vectorization of the group block matrix W_{g}. When the number of input features is huge (e.g. biomedical applications), it is practically impossible to explicitly consider pairwise or even higher-order interactions among all the input feature groups based on simple l₁-penalty or Group Lasso penalty. To solve this problem, we propose a novel way to factorize the block-wise interaction weight matrix W as sum of K rank-one matrices. Each rank-one matrix is represented by an outer product of two identical vectors (termed as rank-one factors) with the grouping structure imposed on these vectors. The feature group interactions of W can be effectively captured by the grouping on the rank-one factors. A feasible decomposition of blockwise W is shown below

$$W = {\sum }_{k = 1}^{K} ( {\sum }_{g ∈ G}^{ } {a}_{kg} ) ⊗ ( {\sum }_{g ∈ G}^{ } {a}_{kg} ) \qquad$$

where [symbol] represents the tensor product/outer product and aₖ is a rank-one factor of W and is given by aₖ=Σ_{g∈G}a_{kg}. The above decomposition is feasible since each rank-one matrix decomposition of W can be represented as weighted combinations of the group block matrices W_{g}.

Now, we can rewrite the optimization problem (4) to identify the discriminative feature groups and pairwise feature group interactions by using the grouped rank-one factors as follows,

$$\begin{matrix}\{ \hat{β} , {\hat{a}}_{k} \} = arg {min}_{{a}_{k} , β} L ( β , {W}_{OD} ) + {P}_{λ} ( β , {a}_{k} ) \\ where , & ( 5 ) \\ {P}_{λ} ( β , {a}_{k} ) = {λ}_{β} {\sum }_{g ∈ G}^{ } {‖ {β}_{g} ‖}_{2} + {\sum }_{k}^{ } {λ}_{{a}_{k}} {\sum }_{g ∈ G}^{ } {‖ {a}_{kg} ‖}_{2} \\ and & ( 6 ) \\ {W}_{OD} = {\sum }_{k = 1}^{K} ( {\sum }_{g ∈ G}^{ } {a}_{kg} ) ⊗ ( {\sum }_{g ∈ G}^{ } {a}_{kg} ) - D ( {\sum }_{k = 1}^{K} {( {\tilde{a}}_{k , i}^{2} )}_{i ∈ [ 1 , p ]} ) & ( 7 )\end{matrix}$$

where \hat{β},âₖ represent the estimated parameters of our model, D is a diagonalizing matrix operator which returns a p×p diagonal matrix, and ã_{k,i} is the i^{th} component of aₖ.

Let Q represent the objective function (loss function with the regularization penalties) i.e. the right hand side of the equation (5). We replace L in (5) by L_{LogReg}(β, W_{OD}, β₀) for logistic regression, and by L_{Hinge}(β, W_{OD}, β₀) for large-margin classification. We call our model Group Factorization based High-order Interaction Model (Group FHIM). In section 4.1 we present a greedy alternating optimization algorithm to solve our optimization problem. Note that we use W_{OD} in equation (5) instead of W. Although the original W is a sum of K rank-one matrix with the maximum rank K, the actual rank of W_{OD} is often much larger than K. However, W and the off-diagonal W_{OD} define the same interaction block-wise patterns between different input features. In practice, we often focus on identifying interpretable discriminative high-order interactions between different features instead of uninteresting self-interactions. Moreover, removing diagonal elements of W has the advantage of eliminating the interference between optimizing β and optimizing aₖ's for binary input feature vectors, which greatly helps our alternating optimization procedure and often results in much better local optimum in practice. Our empirical studies also show that, even for continuous input features, W_{OD} often result in faster parameter learning and better local optima. Therefore, we used W_{OD} instead of W in the objective functions of both FHIM and Group FHIM for all our experiments.

The non overlapping group structure used in Group FHIM limits its applicability in practice. Hence, an extension of Group FHIM can be used for overlapping groups case or Overlapping Group FHIM (denoted by OvGroup FHIM). In OvGroup FHIM, we consider the overlapping group penalty instead of the l₁/l₂ penalty used in Group FHIM. The overlapping group penalty for aₖ is given below.

$${Ω}_{overlap}^{G} ( {a}_{k} ) = v ∈ {V}_{G} , \\ {\sum }_{g ∈ G}^{inf} {v}_{g} = {a}_{k} {\sum }_{g ∈ G}^{ } ‖ {v}_{g} ‖ \qquad ( 8 )$$

The optimization problem in Equation 5 is convex in β but non-convex in aₖ. The non-convexity property of our optimization problem makes it is difficult to propose an optimization strategy which guarantees convergence to global optima. Here, we propose a greedy alternating optimization approach (Algorithm 1) to find a local optima for our problem. We use the Spectral Projected Gradient method for solving our optimization problems (Line 4 and 5) since we found through experiments that it is much faster than other popular approaches such as Quasi-Newton methods.

Greedy Alternating Optimization

1: Initialize β to β_{LASSO}, K = 1 and α_{K} = 1
2: While (K==1) OR (α_{K-1} ≠ 0 for K > 1)
3: Repeat until convergence
4: α^{t}_{K,j} = arg minⱼ Q((α^{t}_{K,t},...,α^{t}_{K,j-1},α^{t-1}_{K,j+1},...

α_{K,p}^{t-1}), β^{t-1})

5: βⱼ^{t} = arg minⱼ Q(β₁^{t},...,βⱼ₋₁^{t},βⱼ₊₁^{t-1},β_{P}^{t-1}),α_{K}^{t})
6: End Repeat
7: K = K + 1; α_{K} = 1
8: End While
9: Return α_{K} and β which has the least loss function.

We use synthetic and real datasets to demonstrate the performance of our Group FHIM and OvGroup FHIM models, and compare it with LASSO, Hierarchical LASSO, Group Lasso, Trace-norm , Dirty model, QUIRE and FHIM. We use 80% of dataset for training and 20% for test, and 20% of training data as validation set to find optimal tuning parameters. We search tuning parameters for all methods using grid search, and for our model the parameters λ_{β} and λₐ_{ₖ} are searched in the range of [0.01,100]. Here we report our results on 5 simulations. Initialization, warm start, and stopping criterion play an important role for our Greedy Alternating Optimization algorithm. Below, we discuss how we choose them for our optimization. From our extensive experimental studies, we found that initializing aₖ with 1 and β with β_{LASSO} works well for convergence.

We generate the features of design matrix X using a normal distribution with mean zero and variance one (N(0,1)). β,aₖ were generated as s-sparse vector from N(0,1), s is chosen as 5-10% of p and the number of groups |G|∈[10,50]. The group interaction weight matrix W_{OD} was generated using equation (7) for a K∈[1,5]. The response vectors y was generated for logistic and large-margin formulation with a noise factor of 0.01. We generated several synthetic datasets by varying n, p, K, |G| and s. Note, we denote the combined total features (that is main effects+pairwise interaction) by q, here q=p(p+1)/2. Here, we show results for synthetic data in these settings: Case 1) n>p and q>n (high-dimensional setting w.r.t interaction features) and Case 2) p>n (high-dimensional setting w.r.t original features).

To assess the performance of our model, we tested our methods on three prediction tasks:

1. Classification on RCC sample: The test dataset contains 213 RCC samples from Benign and 4 different stages of tumor. Expression levels of 1092 proteins are collected in this dataset and these 1092 proteins belong to the 341 groups (overlapping groups). The number of Benign, Stage 1, Stage 2, Stage 3 and Stage 4 tumor samples are 40,101,17,24 and 31 respectively.

2. Gene Expression Prediction: The test dataset has 157 ChIP-Seq signals for transcription factor bindings and chromatin modifications and 1000 samples for gene transcripts. The features were grouped into 101 non-overlapping groups based on prior knowledge about ChIP-Seq experimental setup. For example, different ChIP-Seq experiments under different conditions or treatments for the same transcription factor are grouped into the same group.

3. Peptide-MHC I Binding Prediction: The test dataset has 9 positional groups (non-overlapping) and each positional group contains 20 features which are substitution log-odds from BLOSUM62 for the amino acid at this position.

For synthetic data, we evaluate performance of our methods using prediction error and support recovery experiments. For real dataset, we perform the following evaluations:

1. RCC Classification: We perform 3 stage-wise binary classification experiments using RCC samples:

(a) Case 1: Benign samples vs. Stage 1-4 .

(b) Case 2: Benign and Stage 1 vs. Stage 2-4.

(c) Case 3: Benign, Stage 1,2 vs. Stage 3,4.

2. ChIP-Seq Gene Expression Classification: We perform two binary classification experiments: Case 1) predict gene expression levels as low or high, Case 2) predict whether genes are expressed or not.

3. Peptide-MHC I Binding Prediction: We predict binding peptides from non-binding peptides for three alleles, HLA-A*0201, HLA-A*0206 and HLA-A*2402.

Tables 1 and 2 show that our Group FHIM and OvGroup FHIM outperforms the state-of-the-art approaches such as l₁ Logistic Regression, Group Lasso yuan2006model, Hierarchical Lasso hlasso and FHIM FHIM_KDD. These models (except l₁ Logistic Regression) were chosen for comparison because they are the state-of-the-art approaches which can recover grouping structure or high order feature interactions. FIG. 1 shows an example for the support recovery of W_{OD} for the q>n setting. From this FIG., we see that our model performs very well (i.e. F₁ score is close to 1). For p>n settings, our model also performs fairly well in the support recovery of W_{OD}.

TABLE 1
ROC scores on synthetic data with non-overlapping groups: case
1) q = 5100, n = 1000; case 2) p = 250, n = 100.

| | [symbol] ₁ | | Hier. | | Group FHIM |
|---|---|---|---|---|---|
| | Logistic Reg. | Group Lasso | Lasso | FHIM | (Log. Loss) |
| 1* q > n | 0.52 | 0.74 | 0.58 | 0.89 | 0.97 |
| 1* p > n | 0.51 | 0.52 | — | 0.54 | 0.62 |

Note:
Hier. Lasso has heavy computation burden for p > n.

TABLE 2
ROC scores on synthetic data with overlapping groups:
case 1) q = 5,100, n = 1,000; case 2) p = 250, n = 100.

| | [symbol] ₁ | | | | OvGroup |
|---|---|---|---|---|---|
| | Logistic | Overlap | Hier. | | FHIM |
| | Reg | Group Lasso | Lasso | FHIM | (Hinge Loss) |
| 1* q > n | 0.54 | 0.67 | 0.56 | 0.69 | 0.81 |
| 1* p > n | 0.53 | 0.58 | — | 0.57 | 0.64 |

Next, we report systematic experimental results on classification of samples from different stages of RCC. This dataset does not have grouping information for proteins. In order to group the proteins, we use the web based tool Database for Annotation, Visualization, and Integrated Discovery (DAVID, http://david.abcc.ncifcrf.gov/). There are a set of parameters that can be adjusted in DAVID based on which the functional classification is done. This whole set of parameters is controlled by a higher level parameter—“Classification Stringency”, which determines how tight the resulting groups are in terms of association of the genes in each group. We set the stringency level to ‘Medium’ which results in balanced functional groups where the association of the genes are moderately tight. The total number of groups based on cellular component annotations for RCC is 56. Each ungrouped gene forms a separate group, and in total we have 341 overlapping groups.

The predictive performance of the bio-markers and pairwise group interactions selected by our OvGroup FHIM model (Hinge Loss) is compared against the markers selected by Lasso, All-Pairs Lasso, Group Lasso, Dirty model, QUIRE and FHIM. We use SLEP SLEP, MALSAR malsar packages for the implementation of most of these models. QUIRE and FHIM codes were obtained from the authors. The overall performance of the algorithms are shown in FIG. 2. In this FIG., we report average AUC score for five runs of 5-fold cross validation experiments for cancer stage prediction in RCC. The average ROC scores achieved by feature groups selected with our model are 0.72, 0.93 and 0.95 respectively for the three cases discussed in section 6.2. We performed pairwise t-tests for the comparisons of our method vs. the other methods, and all p-values were below 0.0075 which shows that our results are statistically significant. From FIG. 2, we see that our model outperforms all the other algorithms for the three classification cases of RCC prediction and performs similarly to the well-known biomarker STC1. Interestingly, our OvGroup FHIM did not find any feature group interactions, i.e aₖ=0 for the RCC dataset, and the feature groups (of β_{g}) found by our model corresponds to the two groups containing STC1.

Gene Expression Prediction from ChIP-Seq Signals is detailed next. For case 1, the gene expression measured by Cap Analysis (CAGE) from the ENCODE project above 3.0 (the median of nonzero gene expression levels) is considered as high, while the gene expression between 0 and 3.0 is considered as low for the classification experiments; for case 2, the genes with nonzero expression levels are considered as expressed and the others as non-expressed. Table 4 shows the gene expression prediction results on these two classification experiments. We observed that our Group FHIM outperforms all the state-of-the-art models such as Group l₁ logistic regression and FHIM. Moreover, our model discovers biologically meaningful ChIP-Seq signal interactions which are discussed in the section 6.5.1.

An investigation of the interactions identified by our Group FHIM on the ChIP-Seq dataset reveals that many of these interactions are indeed relevant for gene expression. Among these group interactions, POL2 catalyzes DNA transcription and synthesizes mRNAs and most of small non-coding RNAs, and many transcription factors require its binding to gene promoters to begin gene transcription; MYC is known to recruit histone modifications to activate gene expression; YY1 is known to interact with histone modifications to activate or repress gene expression; SETDB1 regulates histone modifications to repress gene expression; CTCF is an insulator, its binding to MYC locus prevents the expression of MYC to be altered by DNA methylation, and it regulates chromatin structure for which its group also appeared in the dicriminative ones identified by our model. Further investigations of the interactions identified by our Group FHIM model might reveal novel insights that will help us to better understand gene regulation.

TABLE 3
Gene Expression Prediction from ChIP-Seq signals

| | [symbol] ₁ | | | |
|---|---|---|---|---|
| | Logistic | Group [symbol] ₁ | | Group |
| | Reg. | Log. Reg. | FHIM | FHIM |
| Case 1 | 0.74 | 0.90 | 0.82 | 0.92 |
| Case 2 | 0.72 | 0.89 | 0.80 | 0.91 |

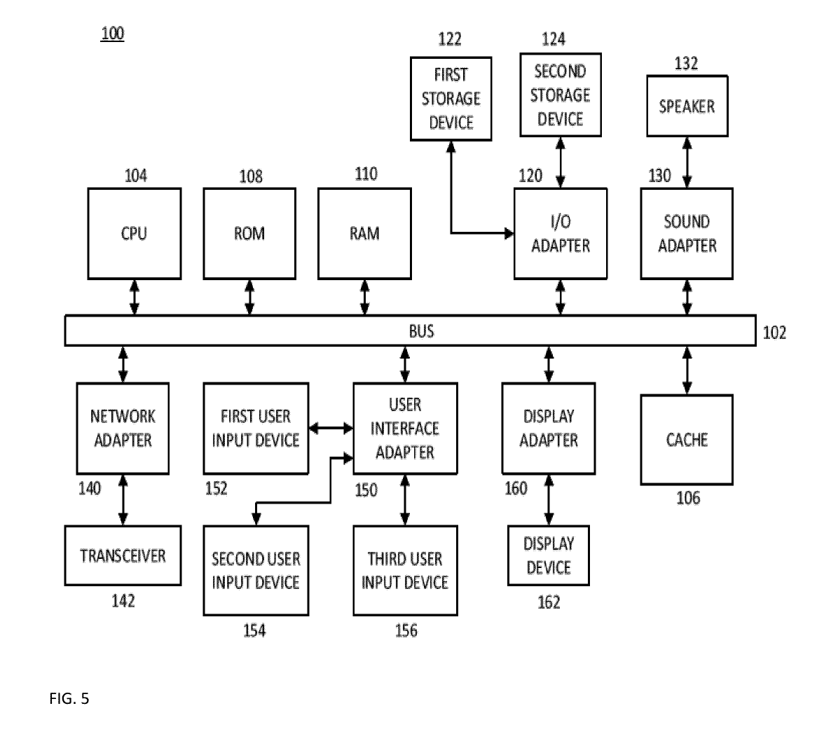

Peptide-MHC I Binding Prediction is discussed next. Table 4 shows the comparison of peptide-MHC I binding prediction of our model with respect to the state-of-the-art l₁ and Group l₁ logistic regression and FHIM. FIG. 5 shows the ROC curves of Group FHIM and Group l₁ logistic regression for Allele 0206. As evident from the AUC scores and ROC curve plots, our method achieves significant improvement over Group l₁ logistic regression in separating the ‘binders’ from ‘non-binders’. We found that l₁ logistic regression gave slightly better performance on A2402, but our model identified meaningful group interactions as discussed below. Group l₁ logistic regression produces worse performance than l₁ logistic regression, which shows that only using grouping information does not help to identify discriminative individual features. However, our model Group FHIM significantly outperforms FHIM, which demonstrates the effectiveness of modeling both grouping information and high-order feature interactions.

TABLE 4
Peptide-MHC I binding prediction AUC score

| | [symbol] ₁ Logistic | Group [symbol] ₁ | | Group |
|---|---|---|---|---|
| Alleles | Reg. | Reg. Log. | FHIM | FHIM |
| A0201 | 0.74 | 0.72 | 0.72 | 0.80 |
| A0206 | 0.76 | 0.75 | 0.68 | 0.79 |
| A2402 | 0.83 | 0.77 | 0.75 | 0.82 |

FIG. 5 with an exemplary processing system 100, to which the present principles may be applied, is illustratively depicted in accordance with an embodiment of the present principles, for operating a machine, to perform FHIM. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

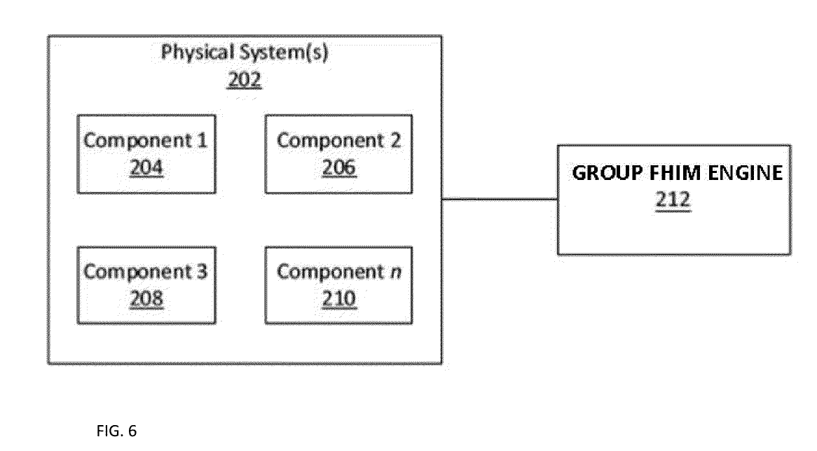

Referring now to FIG. 6, a high level schematic 200 of an exemplary physical system including an FHIM engine 212 is illustratively depicted in accordance with an embodiment of the present principles. In one embodiment, one or more components of physical systems 202 may be controlled and/or monitored using an engine 212 according to the present principles. The physical systems may include a plurality of components 204, 206, 208. 210 (e.g., Components 1, 2, 3, . . . n), for performing various system processes, although the components may also include data regarding, for example, financial transactions and the like according to various embodiments.

In one embodiment, components 204, 206, 208, and 210 may include any components now known or known in the future for performing operations in physical (or virtual) systems (e.g., temperature sensors, deposition devices, key performance indicator (KPI), pH sensors, financial data, etc.), and data collected from various components (or received (e.g., as time series)) may be employed as input to the engine 212 according to the present principles. The engine/controller 212 may be directly connected to the physical system or may be employed to remotely monitor and/or control the quality and/or components of the system according to various embodiments of the present principles.

While the machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

In sum, the knowledge-based sparse learning framework called Group FHIM can identify discriminative high-order feature group interactions in logistic regression and large-margin models. Empirical experiments on synthetic and real datasets showed that our model outperforms several well-known and state-of-the-art sparse learning techniques such as Lasso, l₁ Logistic Regression, Group Lasso, Hierarchical Lasso, and FHIM, and it achieves comparable or better performance compared to the state-of-the-art knowledge based approaches such as QUIRE. Our model identifies high-order positional group interactions for peptide-MHC I binding prediction, and it discovers the important group interactions such as POL2-MYC, YY1-histone modifications, MYC-histone modifications, and CTCF-MYC which are valuable for understanding gene transcriptional regulation.

The inventors contemplate a factorization of the weight matrix W as W=Σₖaₖbₖ^{T} since it is more general and can capture non-symmetric W. Sparsistency can be done P(\hat{θ}_{A}_{^{c}}=0)→1), and the asymptotic oracle properties for pₙ→∞ as n→∞ can also be done.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims and equivalents thereof.

What is claimed is:

1. A method for generating a single task learning framework to predict bio-medical interactions, comprising:
receiving input feature vectors and grouping the features;
factorizing weights into a sum of outer products of vectors;
applying group L1 penalty on factors; and
determining individual features and high-order interactions within groups and between groups for predicting bio-medical interactions.

2. The method of claim 1, comprising performing alternating optimization.

3. The method of claim 2, for pairwise interactions, comprising fixing other weights, and solving each rank-one weight matrix each time.

4. The method of claim 2, for a particular rank-one weight matrix, determining non-zero entries of two corresponding vectors as block-wise interaction feature indices of two densely interacting feature groups.

5. The method of claim 2, for high-order interactions, comprising applying additional rounds of alternating optimization.

6. The method of claim 1, comprising identifying high-order positional group interactions for peptide-MHC I binding prediction.

7. The method of claim 1, comprising identifying group interactions in gene transcriptional regulation.

8. The method of claim 1, comprising identifying group interactions in gene transcriptional regulation including POL2-MYC, YY1-histone modifications, MYC-histone modifications, and CTCF-MYC.

9. The method of claim 1, comprising applying weight matrix factorizations and l₁/l₂ regularization for identifying discriminative high-order feature group interactions in logistic regression and large-margin models.

10. The method of claim 1, comprising factorizing ablock-wise interaction weight matrix W as sum of K rank-one matrices, wherein each rank-one matrix is represented by an outer product of two identical vectors or rank-one factors with a grouping structure imposed on the vectors with a decomposition of blockwise W as:
$$W = {\sum }_{k = 1}^{K} ( {\sum }_{g ∈ G}^{ } {a}_{kg} ) ⊗ ( {\sum }_{g ∈ G}^{ } {a}_{kg} )$$
where [symbol] represents the tensor product/outer product and aₖ is a rank-one factor of W and is given by aₖ=Σ_{g∈G}a_{kg}.

11. A method for generating a single task learning framework to predict bio-medical interactions, comprising:
receiving input feature vectors from bio-medical interactions;
constructing groups over both input features and output tasks;
grouping information among input features, pairwise relationships between outputs, and high-order interactions among input features; and
determining either predictions of multiple tasks or selections of single features or groups of features for the bio-medical interactions.

12. The method of claim 11, comprising identifying high-order positional group interactions for peptide-MHC I binding prediction.

13. The method of claim 11, comprising identifying group interactions in gene transcriptional regulation.

14. The method of claim 11, comprising identifying group interactions in gene transcriptional regulation including POL2-MYC, YY1-histone modifications, MYC-histone modifications, and CTCF-MYC.

15. The method of claim 11, comprising factorizing weight matrices associated with high-order feature interactions, then performing linear regression or logistic regression with L1-=norm penalties over weights associated with single features and high order interaction features; determining L2,1 norm penalty over: a) weights for groups of single features and b) weights associated with interactions between groups and among groups; and determining L1, norm penalty to encourage interaction weights or single feature weights to be similar or dissimilar between pairwise tasks while accounting for task relatedness.

16. The method of claim 1, for biomarker discovery and to handle combinatorial interactions among gene/protein expression measurements for identifying interaction complexes and disease biomarkers, comprising applying single input features and high-order input feature interactions.

17. A method for learning bio-medical data, comprising:
applying weight matrix factorizations and l₁/l₂ regularization; and
identifying discriminative high-order feature group interactions in logistic regression and large-margin models for biomarker discovery and to handle combinatorial interactions among gene/protein expression measurements for identifying interaction complexes and disease biomarkers.

18. The method of claim 17, comprising factorizing ablock-wise interaction weight matrix W as sum of K rank-one matrices, wherein each rank-one matrix is represented by an outer product of two identical vectors or rank-one factors with a grouping structure imposed on the vectors with a decomposition of blockwise W as:
$$W = {\sum }_{k = 1}^{K} ( {\sum }_{g ∈ G}^{ } {a}_{kg} ) ⊗ ( {\sum }_{g ∈ G}^{ } {a}_{kg} )$$
where [symbol] represents the tensor product/outer product and aₖ is a rank-one factor of W and is given by aₖ=Σ_{g∈G}a_{kg}.

19. The method of claim 17, comprising applying single input features and high-order input feature interactions.

20. The method of claim 17, comprising identifying group interactions in gene transcriptional regulation.
